(19) United States
(12) Patent Application Publication
(10) Pub. No.: US 2018/0156214 A1
(43) Pub. Date: Jun. 7, 2018

(54) PUMP UNIT AND ACTUATOR

(71) Applicant: KYB Corporation, Tokyo (JP)

(72) Inventors: Takayuki OGAWA, Tokyo (JP); Takuya KOUGE, Tokyo (JP)

(73) Assignee: KYB Corporation, Tokyo (JP)

(21) Appl. No.: 15/578,522

(22) PCT Filed: Jun. 2, 2016
(86) PCT No.: PCT/JP2016/066381

§ 371 Date: Nov. 30, 2017

(30) Foreign Application Priority Data
Sep. 14, 2015 (JP) 2015-180627

(51) Int. Cl. F04C 15/00; F04C 2/08; F04C 15/06; F15B 11/08

(52) U.S. Cl. CPC F04C 15/0003; F04C 2/084; F04C 15/0061; F04C 15/06; F04C 2240/40; F04C 15/0076; F04C 15/008; F04C 2210/206; F15B 11/08

(57) ABSTRACT

There is provided a pump unit capable of shortening the overall length thereof and maintaining mechanical efficiency even after long-term use and also to provide an actuator having such a pump unit, the pump unit (U) includes a hydraulic pump (P), a motor (M), a coupling (8) coupling a drive shaft (2) of the hydraulic pump (P) and a shaft (7) of the motor (M), a holder (H) having a housing portion (L) that is hollow and houses the coupling (8), and an introduction passage (D) that guides the hydraulic oil to the housing part (L).

### TECHNICAL FIELD

The present invention relates to a pump unit and an actuator.

### BACKGROUND ART

As a pump unit, for example, as disclosed in JP 2013-227943 A, there is a pump unit that includes a hydraulic pump, a motor, a coupling that couples a drive shaft of the hydraulic pump and the shaft of the motor, and an attachment portion that couples the hydraulic pump and the motor and houses the coupling.

In many cases, grease is filled between a coupling and a shaft and between the coupling and a drive shaft in order to prevent the wear of the coupling, the shaft and the drive shaft and to smoothly drive a hydraulic pump by a motor.

Additionally, in a pump unit, the coupling is cylindrical and the shaft of the motor is fitted to the inner periphery of the coupling together with a key to prevent rotation, and as for the prevention of rotation between the drive shaft of the hydraulic pump and the coupling, a spline and the like are used.

### SUMMARY OF THE INVENTION

In the pump unit as described above, since a seal member that seals around the drive shaft is provided in an attachment portion so that hydraulic oil does not enter from a hydraulic pump side, the overall length of the pump unit becomes long.

Additionally, if the pump is used continuously for a long period of time, the grease may escape from the seal member that seals around the drive shaft and enter the hydraulic oil in the hydraulic pump. Usually, a filter for removing contaminants is installed in a hydraulic circuit. There is a case that grease adheres to this filter and hinders the passage of the hydraulic oil through the filter. In such a situation, the mechanical efficiency of the pump unit deteriorates, causing a decrease in discharge pressure and an increase in power consumption.

Accordingly, the present invention has been invented to improve the above-described problems. It is an object of the present invention to provide a pump unit capable of shortening the overall length thereof and maintaining mechanical efficiency even after long-term use and also to provide an actuator including such a pump unit.

A pump unit in a means for solving the problems according to the present invention includes a hydraulic pump, a motor, a coupling that couples a drive shaft of the hydraulic pump and a shaft of the motor, a holder having a housing portion that is hollow and houses the coupling, and an introduction passage that guides the hydraulic oil to the housing portion.

### BRIEF DESCRIPTION OF DRAWINGS

FIG. 1 is a cross-sectional view of a pump unit according to one embodiment of the present invention.

FIG. 2 is a transverse cross-sectional view of a hydraulic pump in the pump unit according to the embodiment of the present invention.

FIG. 3 is a transverse sectional view of a holder in the pump unit according to the embodiment of the present invention.

FIG. 4 is a schematic view of an actuator including the pump unit according to the embodiment of the present invention.

### DESCRIPTION OF EMBODIMENTS

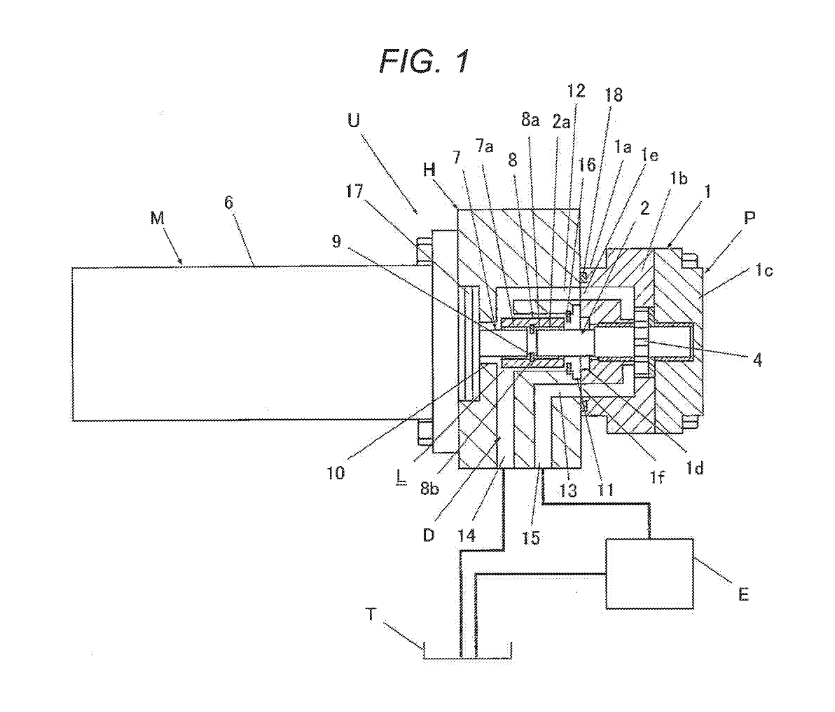

Hereinafter, the present invention will be described on the basis of an embodiment illustrated in the drawings. As illustrated in FIG. 1, a pump unit U of the present embodiment includes a hydraulic pump P, a motor M, a coupling 8 that couples a drive shaft 2 of the hydraulic pump P and a shaft 7 of the motor M, and a holder H that holds the hydraulic pump P and the motor M and also has a housing portion L that is hollow and houses the coupling 8.

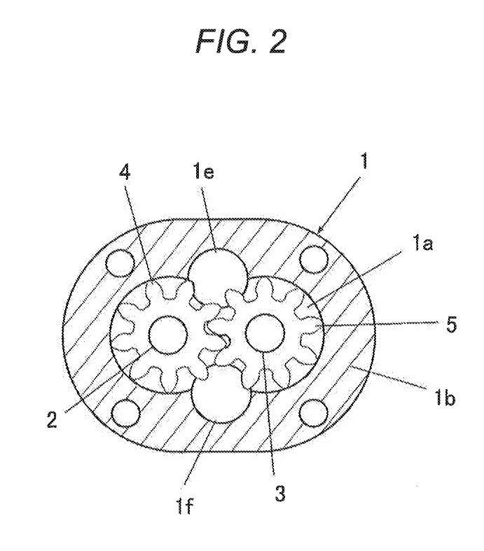

Hereinafter, each part of the pump unit U will be described in detail. As illustrated in FIGS. 1 and 2, the hydraulic pump P includes a case 1 that is hollow, the drive shaft 2 rotatably mounted in the case 1 and protruding into both the inside and the outside of the case 1, a driven shaft 3 rotatably mounted in the case 1, a drive gear 4 mounted on the outer periphery of the drive shaft 2 and rotatably housed in the case 1, a driven gear 5 mounted on the outer periphery of the driven shaft 3 and engaged with the drive gear 4, and rotatably housed in the case 1.

As illustrated in FIGS. 1 and 2, the case 1 includes a case body including a bottom portion 1a and a side wall 1b that is annular and rises from the bottom portion 1a, and a lid portion 1c for closing the opening of the side wall 1b. In addition to a hole 1d through which the drive shaft 2 is inserted, a suction port 1e and a discharge port 1f are provided on the bottom portion 1a.

One end of the drive shaft 2 is inserted into the case 1 through the hole 1d provided in the case 1, and the other end thereof protrudes to the outside of the case 1. The drive shaft 2 has a tip on one end side rotatably held by the lid portion 1c and an intermediate part rotatably held by the bottom portion 1a and is rotatable around an axis with respect to the case 1. Additionally, the drive shaft 2 has a plurality of spline teeth 2a provided on the outer periphery of a tip on the other end side along an axial direction in a circumferential direction.

On the outer periphery of the drive shaft 2, the drive gear 4 housed in the case 1 is mounted. The drive gear 4 rotates in the case 1 together with the drive shaft 2 when the drive shaft 2 is rotationally driven by sliding contact with the bottom portion 1a and the lid portion 1c.

The driven shaft 3 has a tip on one end side rotatably held by the lid portion 1c and the other end rotatably held by the bottom portion 1a and is rotatable around the axis in the case 1. On the outer periphery of the drive shaft 2, the driven gear 5 housed in the case 1 and meshing with the drive gear 4 is mounted. The driven gear 5 is in sliding contact with the bottom portion 1a and the lid portion 1c, and rotates in the case 1 together with the drive gear 4 when the drive gear 4 is rotationally driven. Therefore, when the drive shaft 2 is rotationally driven, the drive gear 4 and the driven gear 5 rotate together in the case 1.

Then, when the drive gear 4 in FIG. 2 is rotated in a clockwise direction, the driven gear 5 rotates in a counterclockwise direction, whereby the hydraulic oil in the case 1 can be transferred from a side of the suction port 1e to a side of the discharge port 1f. Therefore, when the drive shaft 2 is rotationally driven, the hydraulic pump P sucks the hydraulic oil from the suction port 1e into the case 1 and can discharge the hydraulic oil from the discharge port 1f to the outside of the case 1. As described above, in present embodiment, the hydraulic pump P is configured as a gear pump, but may be a vane pump, a piston pump, or the like.

The motor M includes a motor main body 6 that encloses a stator (not illustrated), and the shaft 7 that is rotatably mounted on the motor main body 6 and is rotationally driven by energization of the motor main body 6. It suffices for the motor M to be able to rotationally drive the shaft 7 by energization, and various motors such as AC motor, DC motor, and induction motor can be adopted for the motor M. Additionally, the shaft 7 is provided with a plurality of spline teeth 7a provided on the outer periphery of a tip along the axial direction in a circumferential direction. A seal is provided between the motor main body 6 and the shaft 7, and the interior of the motor main body 6 is densely sealed.

The coupling 8 is cylindrical and has a plurality of spline grooves 8a provided on the inner periphery thereof in a circumferential direction along the axial direction from one end to the other end in a seamless manner. The number of the spline grooves 8a set is equal to the number of the spline teeth 2a of the drive shaft 2 and the number of the spline teeth 7a of the shaft 7. Then, when the tip of the drive shaft 2 is inserted into the coupling 8, the spline teeth 2a mesh with the spline grooves 8a, and the drive shaft 2 is fitted to the coupling 8. Additionally, when a tip of the shaft 7 is inserted into the coupling 8, the spline teeth 7a mesh with the spline grooves 8a, and the shaft 7 is fitted to the coupling 8. When the drive shaft 2 and the shaft 7 are fitted to the coupling 8 in this mariner, the drive shaft 2 and the shaft 7 are prevented from rotating by the coupling 8, and the power of the shaft 7 of the motor M is transmitted to the drive shaft 2, and the drive shaft 2 can be rotationally driven.

Additionally, a groove 8b provided along a circumferential direction is provided in the intermediate inner periphery of the coupling 8, and a snap ring 9 is mounted in the groove 8b. When the snap ring 9 is mounted in the groove 8b, the snap ring 9 functions as a protruding member protruding toward the inside of the inner periphery of the coupling 8. The protruding member may be formed by a member other than the snap ring 9. If the protruding member is provided on the coupling 8, even if the coupling 8 moves in the axial direction, the tip surface of the drive shaft 2 or the shaft 7 comes into contact with the protrusion member and further movement of the coupling 8 in the same direction is restricted, and the coupling 8 is prevented from falling off from the drive shaft 2 and the shaft 7.

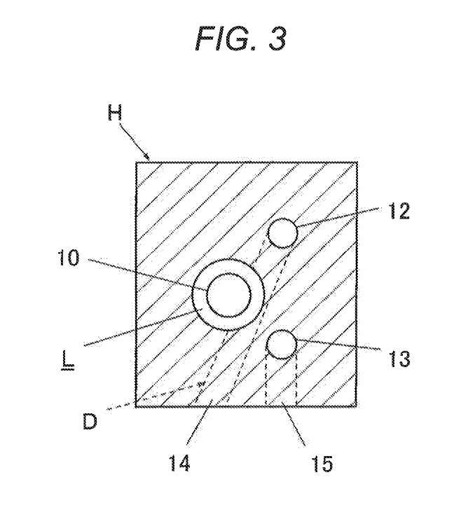

As illustrated in FIGS. 1 and 3, the holder H includes the housing portion L formed in a block shape and with a columnar space inside thereof, a shaft insertion hole 10 that opens from the left end in FIG. 1 and communicates with the housing portion L, a drive shaft insertion hole 11 that opens from the right end in FIG. 1 and communicates with the housing portion L, lateral holes 12 and 13 that open from the right end in FIG. 1, a vertical hole 14 that opens from the lateral side and communicates with the housing portion L and the lateral hole 12, and a vertical hole 15 that opens from a side and communicates with the lateral hole 13.

Then, the motor M is mounted on the left end of the holder H in FIG. 1, and the hydraulic pump P is mounted on the right end in FIG. 1. The shaft 7 of the motor M is inserted into the housing portion L in the holder H through the shaft insertion hole 10, and the drive shaft 2 of the hydraulic pump P is inserted into the housing portion L through the drive shaft insertion hole 11. To attach the motor M and the hydraulic pump P to the holder H, specifically, for example, the following is carried out. First, while the shaft 7 of the motor M is passed through the shaft insertion hole 10, the motor M is brought into contact with the left side of the holder H in FIG. 1. Then, the motor M is bolted to the holder H. Note that for fastening the motor M and the holder H, fastening methods other than bolt fastening may be adopted. When the motor M is attached to the holder H in this manner, since the tip of the shaft 7 is disposed in the housing portion L, the coupling 8 is fitted to the tip of the shaft 7. Since the snap ring 9 as the protruding member is provided in the middle of the inner periphery of the coupling 8, there is also no concern that the coupling 8 deeply fits into the shaft 7 and a fitting margin of the drive shaft 2 decreases. A seal 17 is provided between the motor main body 6 in the motor M and the holder H, and a space between the motor M and the holder H is sealed.

Note that a snap ring 16 is mounted on the inner periphery of the housing portion L of the holder H in the vicinity of the right end in FIG. 1. As the snap ring 16 mounted on the holder H, one having an inner diameter smaller than the diameter of the coupling 8 and larger than a diameter of the drive shaft 2 is adopted. Therefore, in a state in which the motor M is attached to the holder H, even if the motor M is oriented upward and the holder H is oriented downward, the snap ring 16 does not fall from the inside of the housing portion L of the coupling 8. By mounting the snap ring 16 on the inner peripheral end of the housing portion L of the holder H in this manner, the coupling 8 assembled to the holder H is prevented from falling off and the assembling work is facilitated.

Subsequently, the hydraulic pump P is mounted on the right end of the holder H in FIG. 1 while the drive shaft 2 is inserted in the drive shaft insertion hole 11 and fitted to the coupling 8. The drive shaft 2 is fitted to the coupling 8 to bring the hydraulic pump P into contact with the right end of the holder H in FIG. 1. Then, the hydraulic pump P is bolted to the holder H. Note that for fastening the hydraulic pump P and the holder H, fastening methods other than bolt fastening may be adopted. When the motor M and the hydraulic pump P are mounted on the holder H in this manner, the motor M, the hydraulic pump P, and the holder H are united as one to complete the pump unit U. Note that a seal 18 that seals the housing portion L is provided between the hydraulic pump P and the holder H.

Then, when the hydraulic pump P is mounted on the holder H, the suction port 1e provided in the bottom portion 1a of the case 1 of the hydraulic pump P is opposed to the lateral hole 12 provided in the holder H and the suction port 1e and the lateral hole 12 communicate with each other, and similarly, the discharge port 1f is opposed to the lateral hole 13 and the discharge port 1f and the lateral hole 13 communicate with each other.

Additionally, as illustrated in FIG. 1, the vertical hole 14 of the holder H communicates with a tank T that stores the hydraulic oil, and the vertical hole 15 communicates with a hydraulic device E driven by supply of hydraulic pressure. Therefore, the suction port 1e of the hydraulic pump P is connected to the tank T through the lateral hole 12 and the vertical hole 14. In present embodiment, an introduction passage D is formed by the lateral hole 12 and the vertical hole 14. Additionally, the discharge port 1f of the hydraulic pump P is connected to the hydraulic device E through the lateral hole 13 and the vertical hole 15.

Therefore, when the motor M is driven to rotationally drive the drive shaft 2 of the hydraulic pump P, the hydraulic oil is sucked from the tank T through the introduction passage D, and pressure oil can be supplied to the hydraulic device E. Additionally, the introduction passage D communicates between the tank T and the suction port 1e of the hydraulic pump P, and the housing portion L is connected in the middle thereof. Therefore, since the coupling 8 in the housing portion L is immersed in the hydraulic oil, spaces between the coupling 8 and the shaft 7 and between the coupling 8 and the drive shaft 2 are lubricated, and the smooth operation of the hydraulic pump P is guaranteed.

In this manner, the pump unit U includes the hydraulic pump P, the motor M, the coupling 8 that couples the drive shaft 2 of the hydraulic pump P and the shaft 7 of the motor M, and the holder H having the housing portion L that is hollow and houses the coupling 8, and the introduction passage D that guides the hydraulic oil to the housing portion L. Therefore, it is possible to lubricate between the coupling 8 and the shaft 7 and between the coupling 8 and the drive shaft 2 with the hydraulic oil guided to the housing portion L, and a seal member that prevents communication between the interior of the hydraulic pump P and the housing portion L is also unnecessary. Therefore, utilizing the hydraulic oil sucked and discharged by the hydraulic pump P, it is possible to lubricate between the coupling 8 and the shaft 7 and between the coupling 8 and the drive shaft 2, and it is unnecessary to use grease. Consequently, according to the pump unit U of the present invention, the overall length of the pump unit U can be shortened, and the mechanical efficiency can be maintained even after long-term use.

Note that since it suffices for the introduction passage D to be able to guide the hydraulic oil to the housing portion L, instead of the introduction passage D as a passage for supplying the hydraulic oil to the suction port 1e of the hydraulic pump P, as in present embodiment, an introduction passage may be provided separately. Since the introduction passage D communicates with a side of the suction port 1e, high pressure on the discharge side does not act on the housing portion L, a load is not applied to the seal around the shaft 7 of the motor M, and energy loss due to friction against the rotational driving of the shaft 7 can be reduced.

Additionally, as in the present embodiment, when the housing portion L is connected to the middle of the introduction passage D communicating between the tank T and the suction port 1e, the hydraulic oil is sucked into the suction port 1e from the tank T via the introduction passage D during driving of the hydraulic pump P. Therefore, the housing portion L is also filled with the hydraulic oil. Therefore, even if a layout such that the tank T is disposed below the pump unit U is adopted, spaces between the coupling 8 and the shaft 7 and between the coupling 8 and the drive shaft 2 are always lubricated during driving of the hydraulic pump P. Consequently, smooth operation of the motor M and the hydraulic pump P can be guaranteed even if the layout such that the tank T is disposed below the pump unit U is adopted. Additionally, since the introduction passage D connected to the housing portion L is connected to the suction port 1e of the hydraulic pump P, it is unnecessary to provide a passage connecting the suction port 1e and the tank T separately from the introduction passage D, and the holder H can be miniaturized.

Furthermore, in the present embodiment, the spline grooves 8a having no break are provided on the inner periphery of the coupling 8 from one end to the other end along the axial direction. When the spline grooves 8a are configured in this manner, the spline grooves 8a can be formed in a single passage from one end to the other end of the coupling 8 by a single cutting operation. Therefore, it becomes unnecessary to adopt such a process to provide a relief formed in an annular groove along the circumferential direction at the center of the coupling 8 and to cut the spline grooves 8a toward the center from both ends of the coupling 8. Then, since imaginary circles passing through the deepest portion of the spline grooves 8a at both ends of the coupling 8 are concentric and do not deviate from each other, eccentricity between the shaft 7 and the drive shaft 2 can be suppressed. Additionally, since the coupling 8, the shaft 7 and the drive shaft 2 are prevented from rotating by the spline grooves 8a and the spline teeth 2a and 7a, backlash corresponding to a fitting gap is allowed between the coupling 8 and the shaft 7 and between the coupling 8 and the drive shaft 2. Therefore, even if a load for eccentrically displacing the drive shaft 2 in a radial direction acts by the action of high pressure during driving of the hydraulic pump P, the load is difficult to be transmitted to the shaft 7, and a load due to the eccentricity is difficult to act on a ball bearing provided between the motor main body 6 and the shaft 7. Consequently, deterioration of the ball bearing in the motor M can be suppressed. Note that to prevent the coupling 8, the shaft 7, and the drive shaft 2 from rotating, instead of forming the spline grooves 8a and the spline teeth 2a and 7a, serration grooves may be provided in the coupling 8, and the serration grooves may be provided on the outer periphery of the shaft 7 and the drive shaft 2, thereby preventing rotation.

Additionally, in the case where a protruding member protruding toward the inner side of the inner periphery of the coupling 8 is provided on the intermediate inner periphery of the coupling 8, the coupling 8 is prevented from falling off from the drive shaft 2 and the shaft 7.

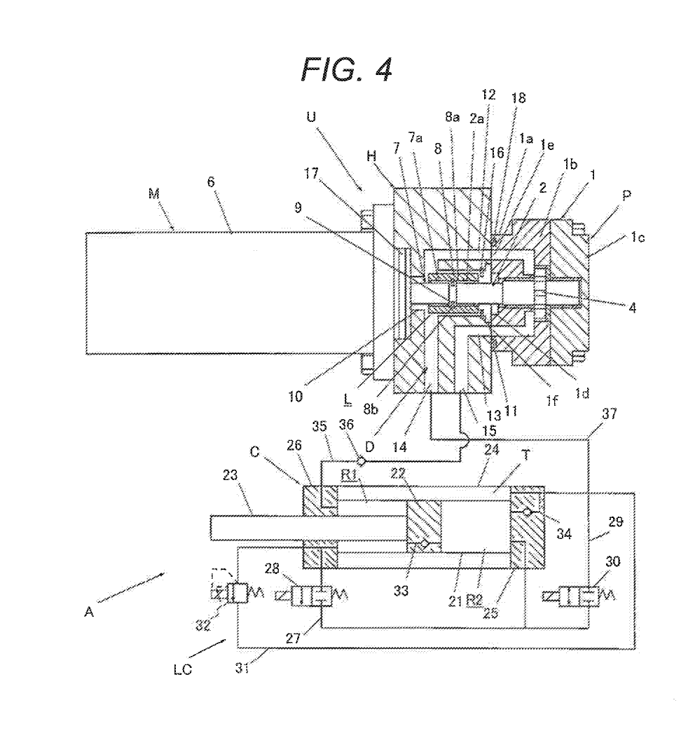

As illustrated in FIG. 1, this pump unit U can be used not only for the hydraulic device E driven by receiving the supply of the pressure oil, but also for an actuator A including this pump unit U, a cylinder body C and a hydraulic circuit LC, as illustrated in FIG. 4. As illustrated in FIG. 1, the actuator A includes the pump unit U, the cylinder body C, and the hydraulic circuit LC.

The cylinder body C includes a cylinder 21, a piston 22 that is movably inserted into the cylinder 21 and partitions the interior of the cylinder 21 into a rod-side chamber R1 and a piston-side chamber R2, a rod 23 inserted in the cylinder 21 and coupled to the piston 22, an external cylinder 24 housing the cylinder 21 therein, a tank T formed between the cylinder 21 and the external cylinder 24, a bottom cap 25 joined with the right end in FIG. 1 that is one end of the cylinder 21 and the external cylinder 24, and a rod guide 26 joined with the left end in FIG. 1 that is the other end of the cylinder 21 and the external cylinder 24 and guides the movement of the rod 23 inserted therein.

The hydraulic circuit LC is configured by including a first on-off valve 28 provided in the middle of a first passage 27 that communicates between the rod-side chamber R1 and the piston-side chamber R2, a second on-off valve 30 provided in the middle of a second passage 29 that communicates between the piston-side chamber R2 and the tank T, a discharge passage 31 that communicates between the rod-side chamber R1 and the tank T, a variable relief valve 32 that can change valve opening pressure provided in the discharge passage 31, and a straightening passage 33 that allows only a flow of the hydraulic oil from the piston-side chamber R2 to the rod-side chamber R1 and a suction passage 34 that allows only a flow of the hydraulic oil from the tank T toward the piston-side chamber R2.

Additionally, the vertical hole 15 leading to the discharge port 1f of the hydraulic pump P in the pump unit U is connected to the rod-side chamber R1 of the cylinder body C through a passage 35. A check valve 36 that blocks only a flow of hydraulic oil from the rod-side chamber R1 to the hydraulic pump P is provided in the middle of the passage 35. Furthermore, the vertical hole 14 leading to the suction port 1e of the hydraulic pump P in the pump unit U is connected to the tank T via a passage 37. In the tank T, the hydraulic oil is stored. Therefore, the hydraulic pump P sucks the hydraulic oil from the tank T and can discharge the pressure oil to the rod-side chamber R1 in the cylinder body C.

Then, the actuator A configured in this manner can be extended and driven when the hydraulic pump P is driven in a state in which the first passage 27 is made a communicating state by the first on-off valve 28 and the second on-off valve 30 is closed. Additionally, the actuator A can be contracted and driven when the hydraulic pump P is driven in a state in which the second passage 29 is made into a communicating state by the second on-off valve 30 and the first on-off valve 28 is closed.

The variable relief valve 32 can adjust the valve opening pressure. Irrespective of the open and closed states of the first on-off valve 28 and the second on-off valve 30, when there is an excessive input in an extending and contracting direction in the actuator A and the pressure of the rod-side chamber R1 exceeds the valve opening pressure, the variable relief valve 32 opens the discharge passage 31 to cause the rod-side chamber R1 to communicate with the tank T. In this manner, in response to the excessive input to the actuator A, the variable relief valve 32 releases the pressure in the rod-side chamber R1 to the tank T to protect the entire system of the actuator A.

In order to cause the actuator A configured in this manner to exert a desired extending-directional thrust force, the first on-off valve 28 is opened, the second on-off valve 30 is closed, and the hydraulic oil is supplied from the hydraulic pump P to the cylinder 21 while the motor M is rotated. In this way, the rod-side chamber R1 and the piston-side chamber R2 are in a communicating state. The hydraulic oil is supplied from the hydraulic pump P to both the rod-side chamber R1 and the piston-side chamber R2. The piston 22 is pushed to the left in FIG. 4, and the actuator A exerts the extending-directional thrust force. When the pressure in the rod-side chamber R1 and the pressure in the piston-side chamber R2 exceeds the valve opening pressure of the variable relief valve 32, the variable relief valve 32 opens and the hydraulic oil escapes to the tank T via the discharge passage 31 and the pressure in the rod-side chamber R1 and the pressure in the piston-side chamber R2 becomes equal to the valve opening pressure of the variable relief valve 32. That is, by adjusting the valve opening pressure of the variable relief valve 32, it is possible to cause the actuator A to exert the extending-directional thrust force obtained by multiplying a difference in pressure receiving area between a side of the piston-side chamber R2 side and a side of the rod-side chamber R1 in the piston 22 by the valve opening pressure of the variable relief valve 32. Note that even if the actuator A is forcibly contracted by an external force, since the pressure in the rod-side chamber R1 and the pressure in the piston-side chamber R2 are controlled to be the valve opening pressure of the variable relief valve 32, the actuator A exerts the extending-directional thrust force that suppresses the contraction.

On the other hand, in order to cause the actuator A to exert a desired contracting-directional thrust force, the first on-off valve 28 is closed and the second on-off valve 30 is opened, and then the hydraulic oil is supplied from the hydraulic pump P into the rod-side chamber R1 while the motor M is rotated. In this way, the piston-side chamber R2 and the tank T are in a communicating state, the hydraulic oil is supplied from the hydraulic pump P to the rod-side chamber R1. The piston 22 is pushed to the right in FIG. 4, and the actuator A exerts the contracting-directional thrust force. Similarly to the above, by adjusting the valve opening pressure of the variable relief valve 32, it is possible to cause the actuator A to exert the contracting-directional thrust force obtained by multiplying the pressure receiving area of the piston 22 on the rod-side chamber R1 side by the valve opening pressure of the variable relief valve 32. Note that even if the actuator A is forcibly extended by an external force, since the pressure in the rod-side chamber R1 is controlled to be the valve opening pressure of the variable relief valve 32, the actuator A exerts the contracting-directional thrust force that suppresses the extension.

Additionally, in the actuator A, when both the first on-off valve 28 and the second on-off valve 30 are closed, the rod-side chamber R1, the piston-side chamber R2, and the tank T are connected by being tied in a row by the straightening passage 33, the suction passage 34, and discharge passage 31. In this state, regardless of whether the hydraulic pump P is driven, when the actuator A is extended and contracted by an external force, the pressure in the rod-side chamber R1 is controlled to be the valve opening pressure of the variable relief valve 32. Therefore, the actuator A acts as a passive damper that exerts a thrust force that suppresses the extension. Then, when the current supply to the motor M, the first on-off valve 28, the second on-off valve 30 and the variable relief valve 32 is cut off, the first on-off valve 28 and the second on-off valve 30 are closed and the variable relief valve 32 functions as a pressure control valve, the valve opening pressure of which is fixed to the maximum. Therefore, the actuator A can function automatically as a passive damper in a state in which the power supply is cut off or when the power supply fails.

When the pump unit U is used for the actuator A configured in this manner, since the overall length of the pump unit U is shortened, the overall size of the actuator A is also reduced, and the mountability of the actuator A to various devices is improved.

Note that the hydraulic circuit LC may have a configuration other than the above-described configuration. For example, the hydraulic circuit LC may selectively supply the pressure oil from the pump unit U to one of the rod-side chamber R1 or the piston-side chamber R2 in the cylinder 21 of the cylinder body C and cause the other of the rod-side chamber R1 and the piston-side chamber R2 to communicate with the tank T. Also in this case, the actuator A can extend and contract by supply of the hydraulic oil from the hydraulic pump P. That is, the hydraulic circuit LC may be any hydraulic circuit LC as long as the hydraulic circuit LC can control the extension and contraction of the actuator A by controlling the communicating state among the hydraulic pump P, the rod-side chamber R1, the piston-side chamber R2 and the tank T.

In present embodiment, the hydraulic pump P sucks all the hydraulic oil from the introduction passage D, but the hydraulic pump P may have a suction passage and the introduction passage D may be provided in parallel with the suction passage.

This application claims priority based on Japanese Patent Application No. 2015-180627 filed to the Japan Patent Office on Sep. 14, 2015, and the entire contents of the application are incorporated herein by reference.

1. A pump unit comprising:
a hydraulic pump;
a motor;
a coupling coupling a drive shaft of the hydraulic pump and a shaft of the motor; and
a holder holding the hydraulic pump and the motor and having a housing portion that is hollow and houses the coupling,
wherein the holder is provided with an introduction passage that guides hydraulic oil to the housing portion.

2. The pump unit according to claim 1,
wherein the introduction passage is connected to a suction port of the hydraulic pump.

3. The pump unit according to claim 2,
wherein the introduction passage connects a tank that stores the hydraulic oil to the suction port in order to supply the hydraulic oil to the hydraulic pump, and
the housing portion is provided between the suction port and the tank in the middle of the introduction passage.

4. The pump unit according to claim 1,
wherein the coupling is cylindrical and has either a plurality of spline grooves and a plurality of serration grooves provided in an inner periphery from one end to the other end along an axial direction in a seamless manner, and
the drive shaft and the shaft have either a plurality of spline teeth fitted to the spline grooves or a plurality of serrated teeth fitted to the serration grooves, and are fitted to the inner periphery of the coupling.

5. The pump unit according to claim 1,
wherein a protruding member protruding inwardly is provided in the middle of the inner periphery of the coupling.

6. An actuator comprising:
the pump unit according to claim 1;
a cylinder;
a piston that is movably inserted into the cylinder and partitions into a rod-side chamber and a piston-side chamber in the cylinder;
an external cylinder housing the cylinder;
a cylinder body having a tank formed between the cylinder and the external cylinder; and
a hydraulic circuit that controls a communicating state among the hydraulic pump, the rod-side chamber, the piston-side chamber, and the tank,
wherein the holder is coupled to the cylinder body,
a suction port of the hydraulic pump is connected to the tank, and
a discharge port of the hydraulic pump is connected to the inside of the cylinder.
